(19) United States
(12) Patent Application Publication
(10) Pub. No.: US 2003/0101539 A1
(43) Pub. Date: Jun. 5, 2003

(54) Sprung hinge for a two-way door

(76) Inventor: Shih-Hao Fang, Taipei (TW)

Correspondence Address: Jones, Tullar & Cooper, P.C., Suite 1002, 2001 Jefferson Davis Highway, Arlington, VA, 22202, US

(21) Appl. No.: 09/998,176

(22) Filed: Dec. 3, 2001

(51) Int. Cl. E05F 1/08

(52) U.S. Cl. 16/302

(57) ABSTRACT

A sprung hinge for a two-way door has a body. The body has two side ends curled to form two barrels. Two springs are respectively mounted inside the barrels. Two adjusting seats are respectively mounted on top of the barrels. Two bases are respectively mounted under the barrels. The adjusting seats and the bases are made of durable plastic. Each spring has a top end and a lower end respectively connected to the corresponding adjusting seat and base. Each barrel is further pivotally connected to a pivoting member. Two axles respectively extend through the barrels and the corresponding adjusting seats and bases. Each axle has two ends respectively and securely mounted with a top cap and a bottom cap, wherein fillers made of the durable plastic are disposed in the top caps and the bottom caps.

### BACKGROUND OF THE INVENTION

1. Field of the Invention

The present invention relates to a sprung hinge for a two-way door. More particularly to a sprung hinge which is silent during operation and has a simple structure to be conveniently manufactured in a low cost way.

2. Description of Related Art

A screen door is a common article fitted at an entrance of a house and together with a primary door. The purpose of the screen door is mainly to prevent insects such as mosquitoes from entering the house while leaving the primary door open to allow fresh air to enter the house. Usually, the screen door is pivotally connected to a door frame via sprung hinges. The sprung hinges are each equipped with a spring so as to provide resilience for automatically shutting the screen door.

However, the mentioned sprung hinge is only suitable for a one-way door which must be opened from a particular direction, but in some occasions, a two-way door is necessary. For example, in stores, warehouses, or factories, people may be carrying things with both hands and cannot open the door in a normal way. Sometimes the people have to lean against or even kick the door. Apparently, the one-way door is inconvenient to operate under these circumstances and a two-way door which can be opened in both directions is adapted.

With reference to FIG. 7, a conventional sprung hinge for the two-way door is shown and includes a body (70) with two side ends curled to form two barrels (72). A torsion spring (80) is disposed inside each barrel (72). A ring (86) is disposed on top of the barrel (72) and an adjusting seat (82) is mounted on top of the ring (86). A pivotal member (90) is composed of a rectangular plate, an upper ear (902) and a lower ear (904). The upper ear (902) and the lower ear (904) extend from corresponding top and bottom edges of the plate and each has an axle hole (9022, 9042) defined therein. The pivotal member (90) is then placed in a manner that the upper ear (902) is on top of the adjusting seat (82) and the lower ear (904) is under the barrel (72). Two top washers (922) are added on two sides of the upper ear (902) and, similarly, two bottom washers (924) are added on two sides of the lower ear (904). An axle (92) further axially extends through the axle hole (9022) of the upper ear (902), the top washers (922), the adjusting seat (82), the torsion spring (80), the bottom washers (924) and the axle hole (9042) of the lower ear (904). Finally, a top cap (94) and a bottom cap (96) are respectively and securely mounted at two ends of the axle (92), and the pivotal member (90) is thereby pivotally connected to the body (70). It is noted that the top washers (922), the bottom washers (924), and the ring (86) are made of durable plastic, and all other remaining components of the sprung hinge are made of metal. The purpose of providing the plastic components is to alleviate noises which would otherwise occur due to rubbing between the metal components in operation of the sprung hinge.

Although providing the plastic components can indeed result in a substantially silent operation of the sprung hinge, the main disadvantage is that adding the plastic adjusting seat and washers will complicate the manufacturing of the sprung hinge and therefore causes excessive manufacturing time and cost.

To overcome the shortcomings, the present invention tends to provide an improved sprung hinge for a two-way door to mitigate or obviate the aforementioned problems.

### SUMMARY OF THE INVENTION

An objective of the present invention is to provide a sprung hinge for a two-way door that has components made of durable plastic to be disposed between metal components of the sprung hinge. The purpose of providing the plastic components is to eliminate noises made by rubbing between the metal components, thereby the sprung hinge is silent during operation.

Another objective of the present invention is to provide a sprung hinge for a two-way door that has a simple structure to be conveniently manufactured in a low cost way.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a sprung hinge for a two-way door in accordance with the present invention;

FIG. 2 is an exploded, perspective view of the sprung hinge;

FIG. 3 is a partially cross-sectional view of the sprung hinge;

FIG. 4 is a schematic, top view of the sprung hinge, wherein the door is closed;

FIG. 5 is a schematic, top view of the sprung hinge, wherein the door is opened from a first direction; and

FIG. 6 is a schematic, top view of the sprung hinge, wherein the door is opened from a second direction.

### DETAILED DESCRIPTION OF THE PREFERRED EMBODIMENT

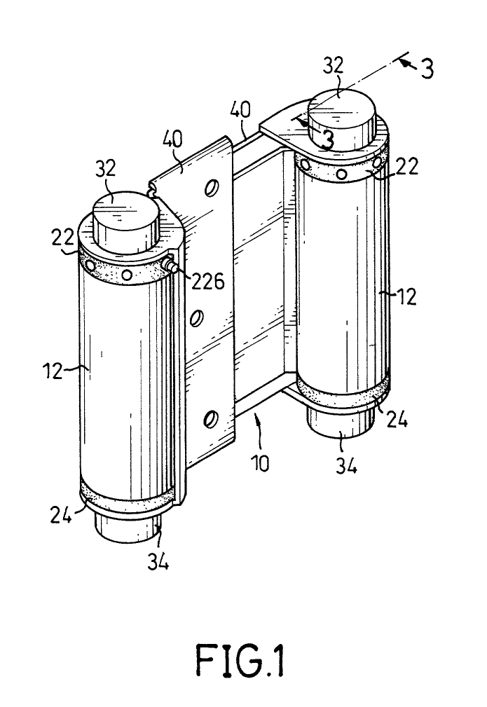

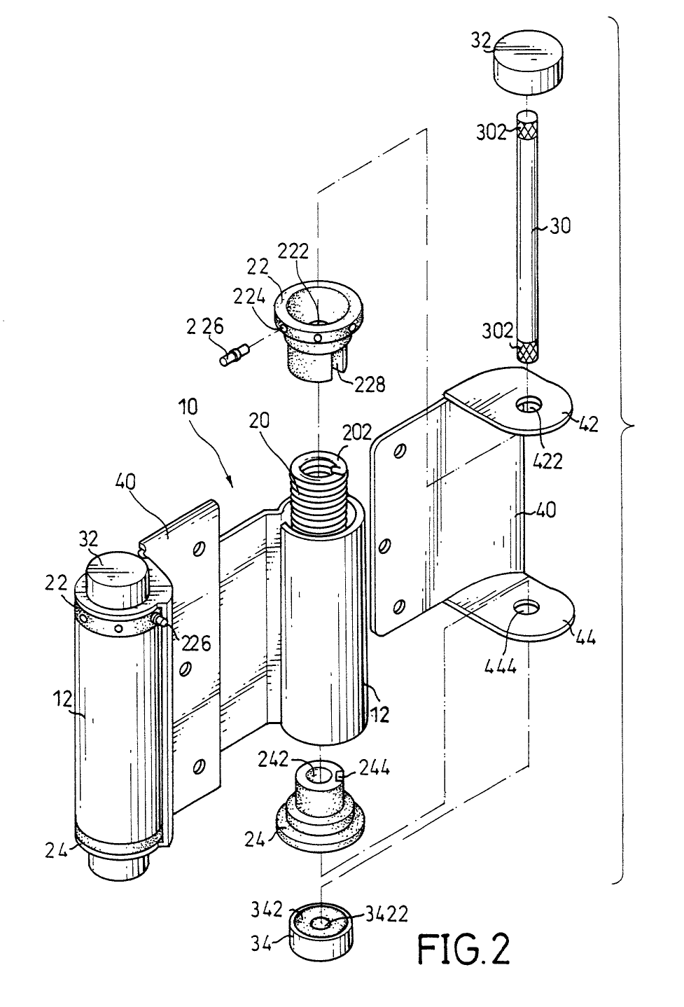

With reference to FIGS. 1 and 2, a sprung hinge for a two-way door in accordance with the present invention has a body (10). The body (10) has two side ends curled to form two barrels (12), and each barrel (12) is pivotally connected with a respective one of two pivotal members (40) and includes a torsion spring (20), an adjusting seat (22), a base (24) and an axle (30). It is noted that two sides of the body (10) are symmetrical and, therefore, the description hereinafter is focused only on one of the sides.

The torsion spring (20) is disposed inside the barrel (12) has a top end and a bottom end, and each end is formed with a protruding foot (202). The adjusting seat (22) is rotatably mounted on top of the barrel (12). Multiple pin holes (224) are defined in and distributed around the adjusting seat (22) to mate with a pin (226). A cutout (228) is defined in the adjusting seat (22) and receives the protruding foot (202) of the top end of the torsion spring (20) so as to couple the top end of the torsion spring (20) with the adjusting seat (22). A through hole (222) is defined through the adjusting seat (22) to allow the axle (30) to extend therethrough. The base (24) is securely mounted under the barrel (12). A notch (244) is defined in the base (24) and receives the protruding foot (202) of the bottom end of the torsion spring (20) so as to couple the bottom end of the torsion spring (20) with the base (24). A through bore (242) is defined through the base (24) to also allow the axle (30) to extend therethrough.

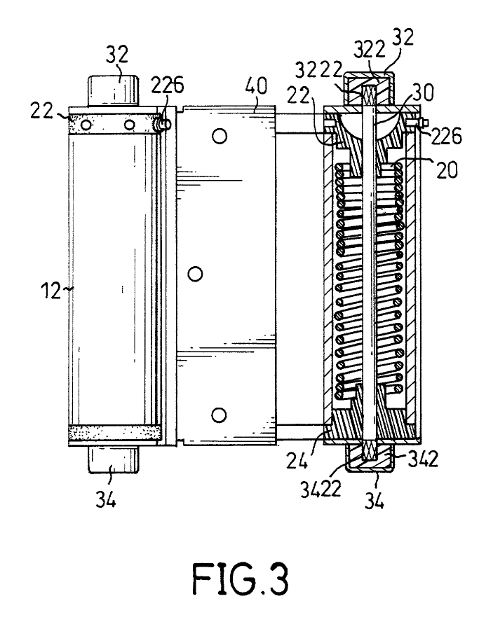

The axle (30) has two ends to be securely connected with a top cap (32) and a bottom cap (34). The ends of the axle (30) each have a rough surface (302). Referring to FIGS. 2 and 3, the top cap (32) has a filler (322) inside and a central hole (3222) defined in the filler (322). Similarly, the bottom cap (34) also has a filler (342) inside and a central hole (3422) defined in the filler (342).

The pivotal member (40) has an upper ear (42) and a lower ear (44) respectively extending from top and bottom edges thereof. An axle hole (422) is defined through the upper ear (42) and similarly an axle bore (444) is defined through the lower ear (44). Both axle hole and bore (422, 444) are defined to allow the axle (30) to freely extend therethrough.

Still referring to FIGS. 2 and 3, when assembling the pivotal member (40) onto the body (10), the upper ear (42) is placed on top of the adjusting seat (22) and the lower ear (44) is placed under the base (24). The axle (30) then axially extends in a sequence through the axle hole (42), the through hole (222), the torsion spring (20), the through bore (242) and the axle bore (444). The top cap (32) and the bottom cap (34) are respectively and securely connected to the two ends of the axle (30) by force fitting the ends into the corresponding central holes (322, 342) of the top and bottom caps (32 and 34), and the rough surfaces (302) firmly engage with inner surfaces defining the central holes (322, 342). Therefore, the axle (30) pivotally connects the pivotal member (40) with the body (10). Furthermore, the pin (226) is selectively received in one of the pin holes (224) defined in the adjusting seat (22) and has a projecting end of the pin (226) abutted to a side edge of the pivotal member (40). Thus, the torsion spring (20) can be twisted in advance and secured afterward by the pin (226) so as to pre-stress the torsion spring (20).

It is noted that the adjusting seat (22), the base (24), and the fillers (342, 322) are all made of durable plastic. Remaining components of the sprung hinge are preferably made of metal.

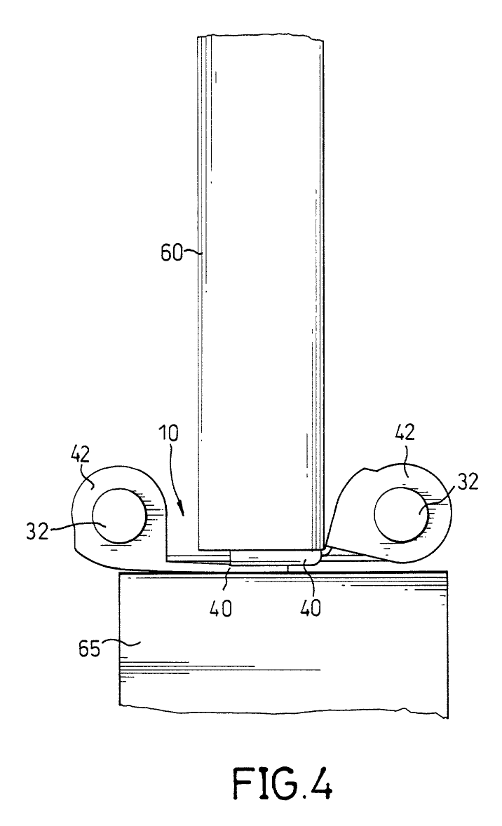

With reference to FIG. 4, when using the sprung hinge in accordance with the present invention to pivotally connect a two-way door (60) onto a door frame (65), one of the pivotal members (40) is securely connected to the door (60), and the other pivotal member (40) is securely connected to the door frame (65).

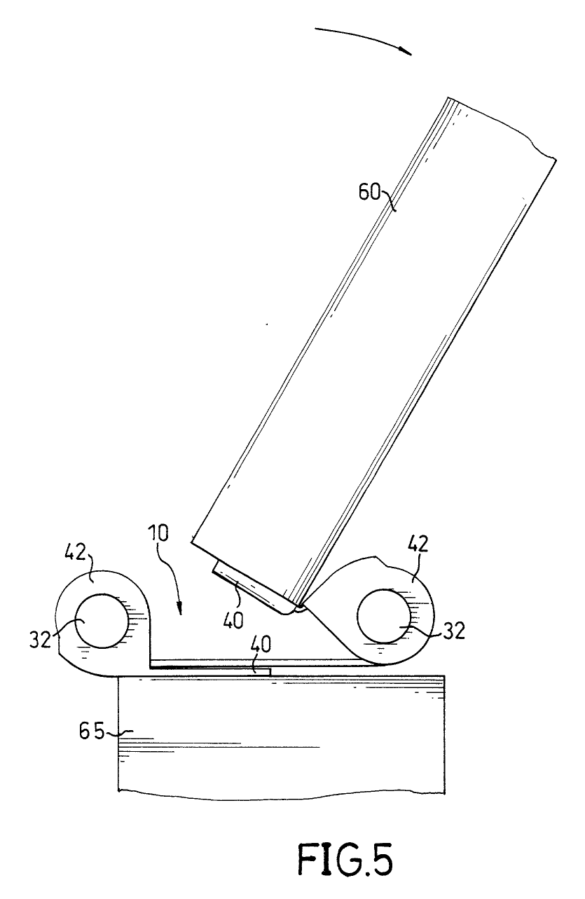

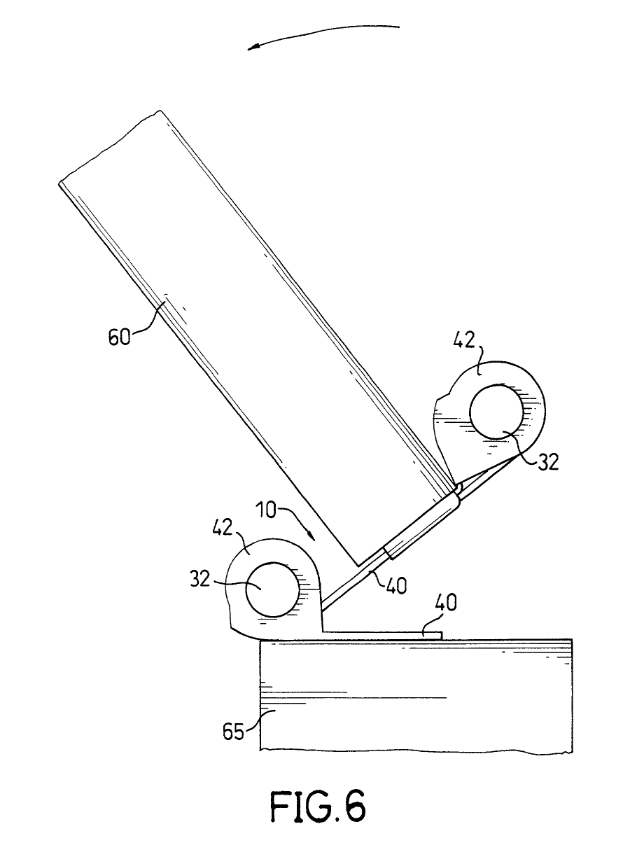

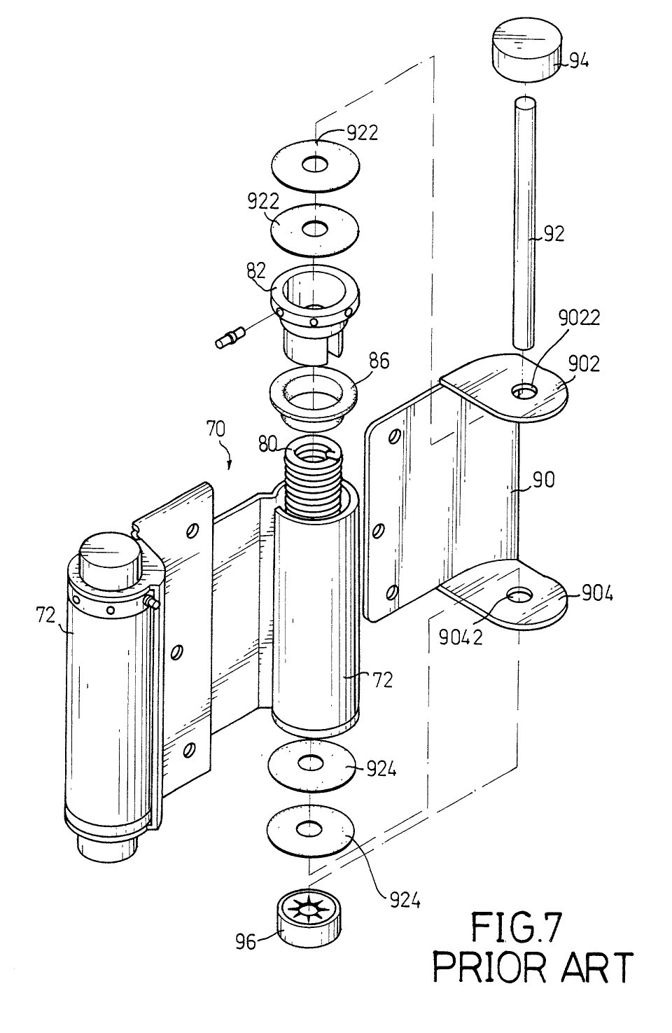

When the door is opened from a first direction shown in FIG. 5, one of the pivotal members (40) remains stationary and the other pivotal member (40) pivots according to the movement of the door (60). When the door (60) is opened from a second direction shown in FIG. 6, the body (40) pivots to allow the door (60) to be pivoted accordingly. Therefore, it is apparent that the door (60) can be opened in both directions. Moreover, no matter in which of the directions mentioned the door (60) is opened, the corresponding one of the torsion springs (20) will be twisted and thus provides a return resilience to close the door automatically right after the opening.

It is noted that the characteristics and advantages of the present invention are that the plastic components, that is, the adjusting seat (22), the base (24), and the fillers (342, 322) are disposed between the metal components of the sprung hinge so that potential noises caused by direct rubbing of the metal components against each other are therefore prevented. Furthermore, the sprung hinge has a simple structure to be conveniently manufactured. More specifically, if comparing the sprung hinge in accordance with the present invention with the conventional sprung hinge shown in FIG. 7, the top washers (922), the bottom washers (904), and the ring (86) are omitted so that the manufacturing and assembling procedures are simplified, and therefore the cost and time associated with manufacturing is reduced.

While this invention has been particularly shown and described with references to the preferred embodiment thereof, it will be understood by those skilled in the art that various changes in form and details may be made therein without departing from the scope of the invention encompassed by the appended claims.

What is claimed is:

1. A sprung hinge for a two-way door, comprising:
a body having two opposite sides each curled as a barrel;
two springs respectively mounted inside the barrels;
two adjusting seats respectively mounted on a top of the barrels, and respectively coupled to top ends of the springs, wherein the adjusting seats are made of a durable plastic;
two bases securely and respectively mounted under the barrels, and respectively coupled to bottom ends of the springs, wherein the bases are made of the durable plastic;
two pivotal members pivotally and respectively connected to the barrels;
two axles respectively extending through the two barrels and the two pivotal members to pivotally connect the pivotal members to the two barrels; and
two top caps and two bottom caps respectively and securely mounted on top ends and bottom ends of the axles, wherein the top caps and the bottom caps each has a filler made of the durable plastic fitted thereinside, and the filler has a central hole defined therein, wherein the top ends and the bottom ends of the axles are force fitted in the corresponding central holes.

2. The sprung hinge as claimed in claim 1, wherein the top ends and the bottom ends of the axles are formed with rough surfaces, and the rough surfaces firmly engage with inner surfaces defining the central holes of the fillers to securely connect the top caps and the bottom caps onto the axles.

3. The sprung hinge as claimed in claim 1, wherein each one of the two adjusting seats has multiple pin holes defined therein to selectively receive a pin so that the pin abuts to the pivotal member to pre-stress the spring.
